(19) United States
(12) Patent Application Publication
(10) Pub. No.: US 2013/0159110 A1
(43) Pub. Date: Jun. 20, 2013

(54) TARGETING USERS OF A SOCIAL NETWORKING SYSTEM BASED ON INTEREST INTENSITY

(71) Applicants: Giridhar Rajaram, Cupertino, CA (US); Nuwan Sanaratna, Sunnyvale, CA (US)

(72) Inventors: Giridhar Rajaram, Cupertino, CA (US); Nuwan Sanaratna, Sunnyvale, CA (US)

(21) Appl. No.: 13/326,289

(22) Filed: Dec. 14, 2011

(51) Int. Cl. G06Q 30/02

(52) U.S. Cl. 705/14.66

(57) ABSTRACT

A social networking system may enable advertisers to target advertisements to users interested, in varying levels of intensity, in concepts, locations, pages, and other objects on the social networking system. Targeting criteria for advertisements may include explicit interest intensity levels in selected objects. Using past histories of user engagement, location information, and social graph information, a social networking system may generate a predictive model to estimate interest intensity levels of users in the selected objects. Advertisements may be targeted and provided to users based on interest intensity using the predictive model.

### BACKGROUND

This invention relates generally to social networking, and in particular to targeting advertisements to users of a social networking system based interest intensity in particular objects.

Traditional advertisers relied on massive lists of keywords to target audiences based on their interests. For example, a sports drink advertiser may target audiences that are interested in sports, such as baseball, basketball, and football, among others. However, advertisements may be presented in locations and at times where the audiences are not actively engaging in an activity related to the product. This leads to wasted ad spending because audiences may not pay attention to the advertisement for lack of relevance.

In recent years, social networking systems have made it easier for users to share their interests and preferences in real-world concepts, such as their favorite movies, musicians, celebrities, brands, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Although advertisers may have some success in targeting users based on interests and demographics, tools have not been developed to target users based on interest intensity.

Specifically, users that have expressed varying levels of interest in particular objects have not been targeted by a social networking system. A social networking system may have millions of users that have expressed varying levels of interest in a multitude of objects, such as movies, songs, celebrities, brands, sports teams, and the like. However, existing systems have not provided efficient mechanisms of targeting advertisements to these users based on interest intensity.

### SUMMARY

A social networking system may enable advertisers to target advertisements to users interested, in varying levels of intensity, in concepts, locations, pages, and other objects on the social networking system. Targeting criteria for advertisements may include explicit interest intensity levels in selected objects. Using past histories of user engagement, location information, and social graph information, a social networking system may generate a predictive model to estimate interest intensity levels of users in the selected objects. Advertisements may be targeted to users based on interest intensity using the predictive model.

### BRIEF DESCRIPTION OF THE DRAWINGS

FIG. 1 is high level block diagram illustrating a process of targeting advertisements to users of a social networking system based on targeted interest intensity criteria, in accordance with an embodiment of the invention.

FIG. 2 is a network diagram of a system for targeting advertisements to users of a social networking system based on targeted interest intensity criteria, showing a block diagram of the social networking system, in accordance with an embodiment of the invention.

FIG. 3 is high level block diagram illustrating an interest intensity targeting module that includes various modules for targeting advertisements to users of a social networking system based on targeted interest intensity criteria, in accordance with an embodiment of the invention.

FIG. 4 is a flowchart of a process of targeting advertisements to users of a social networking system based on targeted interest intensity criteria, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is further described in a related application, “Structured Objects and Actions on a Social Networking System,” U.S. application Ser. No. 13/239,340 filed on Sep. 21, 2011, which is hereby incorporated by reference.

Advertisers may engage with users of a social networking system through different communication channels, including direct advertisements, such as banner ads, indirect advertisements, such as sponsored stories, generating a fan base for a page on the social networking system, and developing applications that users may install on the social networking system. An advertiser benefits from identifying users based on interest intensity levels related to the advertiser's product, brand, application, as well as other concepts and objects on the social networking system because advertisers may more effectively target their advertisements, providing different advertisements based on the interest intensity levels. In turn, a social networking system benefits from increased advertising revenue by enabling advertisers to target users based on interest intensity levels for objects because the social networking system may modify bid prices for users based on their interest intensity levels.

A social networking system may receive targeting criteria for an advertisement from an advertiser that includes a targeted interest intensity level for an object in the social networking system, in one embodiment. For example, an advertiser may wish to target an interest in baked goods, a celebrity such as Britney Spears, a recent movie release for Transformers, or the playoff race for the 2011 Major League Baseball World Series. Users of the social networking system may express varying levels of interest intensity in these concepts by interacting with various content objects on the social networking system, such as a user submitting an RSVP to an event object for Game 1 of the World Series, a photo uploaded by a user with a comment mentioning a Britney Spears concert, a status update mentioning the new Transformers movie by a user, a check-in event at a cupcake bakery, and the like. Users may also indicate that they are going to watch the World Series at an informal gathering at a user's house. Targeting criteria may be loosely defined to include a broad range of users that have interacted with selected objects on the social networking system, in one embodiment. In another embodiment, a targeted interest intensity level in a selected object may be specified by an advertiser in the targeting criteria. As a result, a targeting cluster generated from the received targeting criteria may include users having the specified interest in the object, users connected to other users having the specified interest, as well as any user that satisfies a rule including the specified interest, such as users creating a check-in event with 50 miles of the object (in the case where the object includes a geographic location), users mentioning the object in a content post, users sharing links posted about the object, and so on.

In yet another embodiment, a social networking system may infer targeting criteria of advertisements to users of the social networking system based on the content of the advertisements and determined interest intensity levels of users. In a further embodiment, a social networking system may enable advertisers to select targeting criteria that includes “super fans,” or users that are highly-active and engaging with a specified page or concept on the social networking system. The social networking system may identify users as super fans of the page or concept by analyzing past user engagement history, interactions with other users of the social networking system with respect to the page or concept, as well as influence metrics of users in driving secondary engagement of other users with the page or concept as determined by the social networking system.

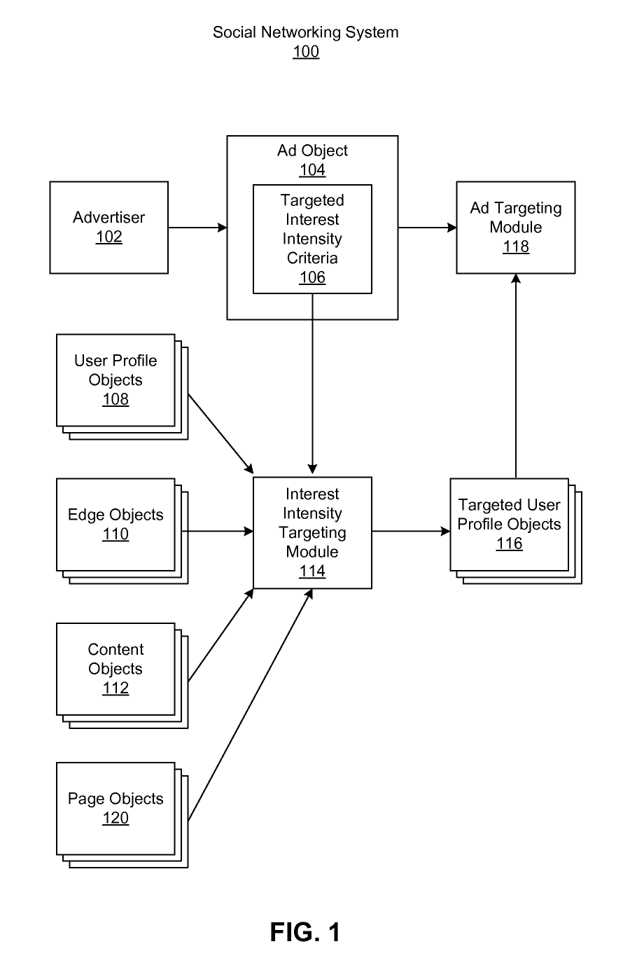

FIG. 1 illustrates a high level block diagram of a process of targeting advertisements to users of a social networking system based on targeted interest intensity criteria, in one embodiment. The social networking system 100 includes an advertiser 102 that provides an ad object 104 that includes targeted interest intensity criteria 106 to the social networking system 100. The targeted interest intensity criteria 106 may include any type of interest in a concept or a page, such as a small interest in technology, inferred by the social networking system 100 in response to a user viewing an article about Steve Jobs, a deeper interest in pop music, inferred by the social networking system 100 in response to a user sharing a link to a page dedicated to Justin Bieber, installing an application for a music streaming service, and listening to over a hundred pop songs over a week, to a passionate interest in exercise, inferred by the social networking system 100 in response to a user commenting on a page for jogging, performing check-in events regularly at gyms, using a third-party application to track caloric intake that shares information with the social networking system 100, posting links to exercise blogs, and the like. The social networking system 100 may enable the targeted interest intensity criteria 106 to be as specific or as broad as desired by the advertiser 102. For example, a range of interest intensity levels may be provided to an advertiser for a specified object, such as a range of 70-100. As another example, a percentage of users with an interest in a specified object may be selected by interest intensity levels, such as selecting the top quartile of users based on their interest intensity levels. An advertiser 102 may also be enabled to select a specific value for a targeted interest intensity level in an object for targeted interest intensity criteria 106 for an ad object 104. In one embodiment, a specific interest intensity level in an object, such as an interest intensity level of 80 for the San Francisco Giants, may be included in the targeted interest intensity criteria 106. In another embodiment, categories of interests, such as broad category interests like jogging, running, yoga, and music, as well as interests that may be unified by a common theme, such as teen pop stars (including interests in Britney Spears, Lady Gaga, and Justin Bieber), may also be specified by the targeted interest intensity criteria 106.

In yet another embodiment, the advertiser 102 may provide an ad object 104 without targeted interest intensity criteria 106. In that embodiment, the ad targeting module 118 may analyze the content of the ad object 104 to target the advertisement based on a matching algorithm that may use interest intensity levels of users in an object to select an advertisement for a viewing user. A matching algorithm that matches an advertisement to a viewing user, based on a likelihood that the user will click on the ad or other predictions, may use the interest intensity levels in objects as part of a prediction model that predicts click-through rates of the advertisements. The matching algorithm may, in one embodiment, use various features, such as historical click-through rates on advertisements, user demographics, and ad creative features to decide the best ad to show to a viewing user. Using estimated interest intensity levels of users, the social networking system may provide advertisements to the users of the social networking system as a result of inferred targeting based on the matching algorithm.

The targeted interest intensity criteria 106 is received by an interest intensity targeting module 114. The interest intensity targeting module 114 analyzes information about users of the social networking system 100 to determine targeted users that have interest intensity levels in a specified object described in the targeted interest intensity criteria 106. In another embodiment, the interest intensity targeting module 114 may determine targeted users that are connected to other users that have interest intensity levels in a specified object described in the targeted interest intensity criteria 106. The interest intensity targeting module 114 retrieves information about users from user profile objects 108, edge objects 110, content objects 112, and page objects 120. User profile objects 108 include declarative profile information about users of the social networking system 100. Edge objects 110 include information about user interactions with other objects on the social networking system 100, such as clicking on a link shared with the viewing user, sharing photos with other users of the social networking system, posting a status update message on the social networking system 100, and other actions that may be performed on the social networking system 100. Content objects 112 include objects created by users of the social networking system 100, such as status updates that may be associated with photo objects, location objects, and other users, photos tagged by users to be associated with other objects in the social networking system 100, such as events, pages, and other users, and applications installed on the social networking system 100. Page objects 120 include information about a page on the social networking system 100, such as properties of the page, a listing of users currently viewing the page, and content objects 112 associated with the page, such as page posts, comments by users, and the like.

The interest intensity targeting module 114 analyzes the information about the users of the social networking system 100 retrieved from the user profile objects 108, edge objects 110, content objects 112, and page objects 120 to identify targeted user profile objects 116 that have been determined to have interest intensity levels in an object as specified in the targeted interest intensity criteria 106. In one embodiment, the interest intensity targeting module 114 may determine users as “super fans” of a particular page or concept, based on the number and frequency of comments and status updates mentioning the page or concept, invitations sent to other users to join the page, viewing the page frequently over a given time period, and other interactions with the page or concept that indicates a high level of engagement. Responsive to targeted interest intensity criteria 106 of an ad object 104 that specifies targeting “super fans” of a particular page or concept on the social networking system 100, the interest intensity targeting module 114 identifies targeted user profile objects 116 associated with the users that have been identified as “super fans.” The interest intensity targeting module 114 may also identify other users connected to the identified “super fans” based on affinity scores of the other users for the “super fans” even if the other users do not have an interest in the object specified in the targeted interest intensity criteria 106. In one embodiment, interest intensity levels may be inferred by the interest intensity targeting module 114 based on analyzing user profile objects 108, edge objects 110, content objects 112, and page objects 120. For example, a user who has expressed strong interests in Starbucks Coffee and for the Home and Garden Television Network may be inferred to have strong interests in the broad category interest of “coffee” and “home decor,” which may then be targeted by an advertiser for a espresso coffee machine. Machine learning algorithms may be used in generating these inferences based on the information received about users of the social networking system 100.

Interest intensity levels may be determined by the interest intensity targeting module 114 based on information extracted from user profile objects 108, edge objects 110, content objects 112 and page objects 120 associated with a specified object in the targeted interest intensity criteria 106. In one embodiment, affinity scores of users for the specified object may be determined by the social networking system 100 based on interactions with the specified object over time. The affinity scores of users may be computed for various objects based on actions performed on those objects, such as sharing a link to the object, commenting on the object, installing the object, and the like, as further described in a related application, “Contextually Relevant Affinity Prediction in a Social Networking System,” U.S. patent application Ser. No. 12/978,265, filed on Dec. 23, 2010, which is hereby incorporated by reference. In another embodiment, a user may be currently viewing a page or may have just posted a comment mentioning a particular concept. An advertiser 102 may specifically include in targeted interest intensity criteria 106 for an ad object 104 that the advertisement should be dynamically targeted to that user viewing a specified page or completing an action that mentions a particular concept, in real-time. In this way, the advertiser 102 may have to pay a high price for targeting that user based on the contextual signals, but the predicted click-through rate (CTR) of the advertisement may be higher as a result. In one embodiment, this real-time interest information may be included in a matching algorithm for targeting an advertisement to a user by inferring targeting of the advertisement based on content of the advertisement and the real-time interest information.

A social networking system 100 implements a bid auction system for providing advertisements to users of the social networking system. As a publisher of the advertisements, the social networking system 100 may charge higher cost-per-click (CPC) prices for users based information relevant to the likelihood that users will click on the advertisement, such as this real-time information about interest in an object, or other interest intensity level information about users determined by the social networking system 100. Timelier, and therefore more relevant, advertisements may have higher bid prices for users that have recently performed an action on an object specified in the targeted interest intensity criteria 106 as well as users that have high interest intensity levels for an object specified in the targeted interest intensity criteria 106 either organically, through the bid auction system, or artificially, through the social networking system 100 charging a premium for these highly interested users. In one embodiment, an advertiser may bid a higher CPC amount to reach more interested users and a lower CPC amount to reach less interested users. This results in effect ad campaign budget utilization for advertisers and enables the social networking system 100 to more accurately model the supply and demand for ads based on user interest. In another embodiment, a predetermined threshold for a “super fan” may be defined in the targeting criteria for an advertisement, and a higher bid price, or a reserve bid price, may be required to reach those users meeting the “super fan” threshold of interest intensity level in the object.

An ad targeting module 118 receives the targeted user profile objects 116 identified by the interest intensity targeting module 114 for providing the advertisement embodied in the ad object 104 to the users associated with the targeted user profile objects 116. The advertisement may be provided to users of the social networking system 100 through multiple communication channels, including mobile devices executing native applications, text messages to mobile devices, websites hosted on systems external to the social networking system 100, and ad delivery mechanisms available on the social networking system 100, such as sponsored stories, banner advertisements, and page posts. As viewing users associated with the targeted user profile objects 116 interact with the social networking system 100, the ad object 104 may be provided to the viewing users for display by the ad targeting module 118 based on the targeted interest intensity criteria 106.

### System Architecture

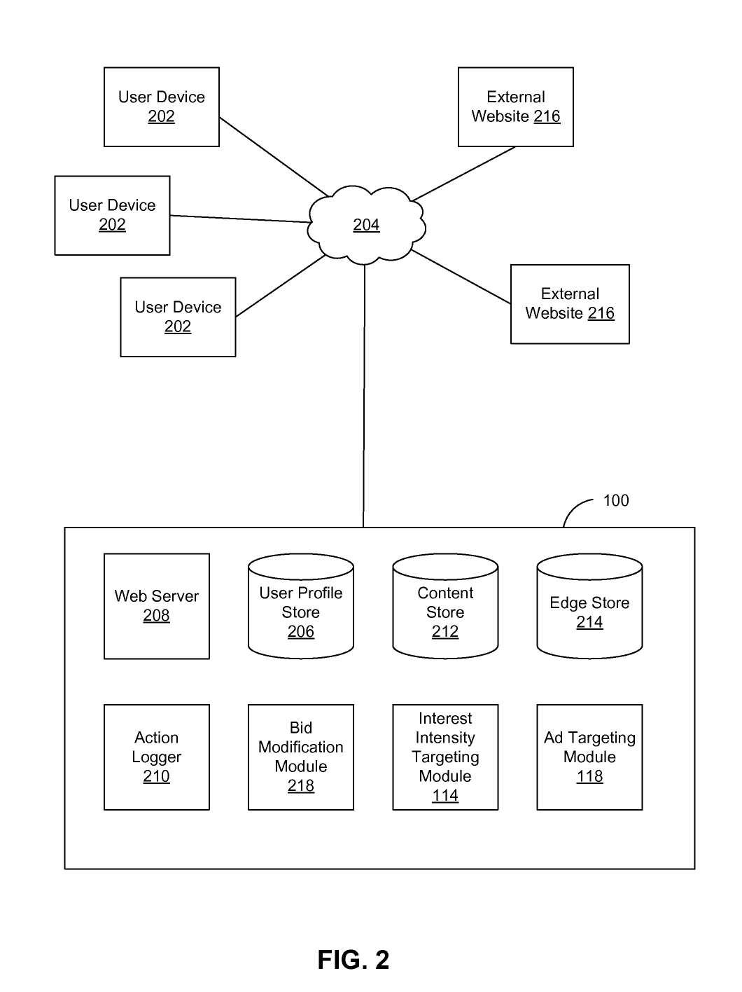

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 216. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes a user profile store 206, an interest intensity targeting module 114, an ad targeting module 118, a web server 208, an action logger 210, a content store 212, an edge store 214, and a bid modification module 218. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects 108 in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100 in edge objects 110. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

An interest intensity targeting module 114 receives targeted interest intensity criteria 106 included in ad objects 104 that are stored in the content store 212, in one embodiment. Using information about users of the social networking system 100, from user profile objects 108 retrieved from the user profile store 206, edge objects 110 retrieved from the edge store 214, and content objects 112 and page objects 120 retrieved from the content store 212, the interest intensity targeting module 114 may determine interest intensity levels that measure the interest that users have in the object described in the targeted interest intensity criteria 106. Machine learning algorithms may be used to generate interest intensity levels based on past histories of users' engagement with the specified object. Additionally, machine learning algorithms may infer users' interest in the specified object based on the information retrieved about the users and analysis of the real-time information about the users with respect to the specified object. As a result, the interest intensity targeting module 114 may identify users that have interest intensity levels matching, exceeding, or within a range of the targeted interest intensity for an object described in the targeted interest intensity criteria 106.

An ad targeting module 118 may receive targeting criteria for advertisements for display to users of a social networking system 100. The ad targeting module 118 provides advertisements to users of the social networking system 100 based on the targeting criteria of the advertisements. In one embodiment, targeted interest intensity criteria 106 may be received for advertisements and processed by the interest intensity targeting module 114. After the interest intensity targeting module 114 identifies users that have interest intensity levels in an object as described in the targeted interest intensity criteria 106, the ad targeting module 118 may target the advertisement to those identified users. Targeting criteria may also be received from advertisers to filter users by demographics, social graph information, and the like. Other filters may include filtering by interests, applications installed on the social networking system 100, groups, networks, and usage of the social networking system 100. In another embodiment, targeting criteria may be inferred by the ad targeting module 118 based on information in a viewing user's profile and the content of the advertisement. In this way, the interest intensity levels in one or more objects associated with the viewing user may be used in targeting an advertisement associated with the same one or more objects.

A bid modification module 218 may adjust bids for advertisements based on a number of factors. In one embodiment, a social networking system 100 may enable advertisers to modify a maximum bid for a click for users depending on an interest intensity level in a specified object of the users. For example, an advertiser that targets users that are very interested in movies, determined from a large number of status updates, expressions of interests (or “likes”), as well as membership in various groups about movies, may pay different cost-per-click (CPC) bids based on different interest intensity levels to target clusters of users that with higher interest intensity levels for movies. In another embodiment, the social networking system 100 may impose a premium fee to enable this feature of targeting advertisements based on interest intensity levels. In a further embodiment, the social networking system 100 may determine a reserve CPC price for a particular interest intensity level for a specified object that enables an advertiser to exclusively use that interest intensity targeting criteria, such that other advertisers are unable to target their advertisements using that particular interest intensity level for the specified object. The bid modification module 218, using a machine learning algorithm, may then decide to increase or decrease the reserve CPC price based on the marketplace bidding on interest intensity levels for the specified object. Other factors used by the bid modification module 218 to modify a reserve CPC price may include ad inventory, user behavior patterns, and the distribution of interest intensity levels of users. As a result, advertisers may reach more relevant audiences while the social networking system may benefit from increased engagement and advertising revenues.

### Interest Intensity Targeting on a Social Networking System

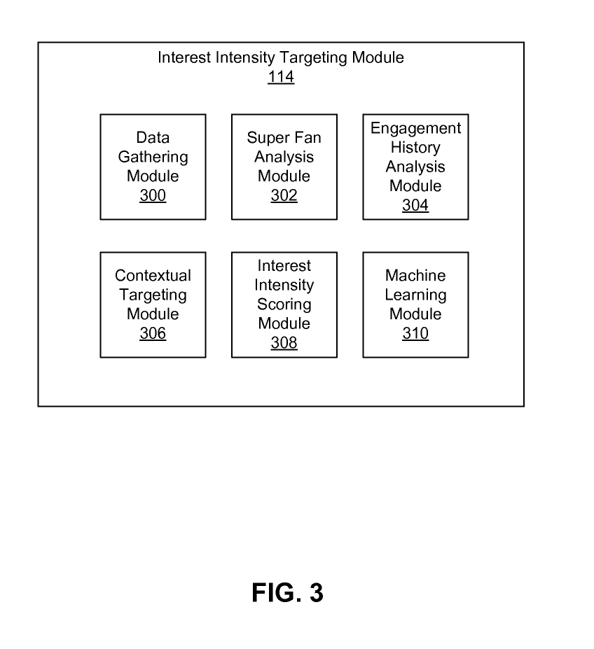

FIG. 3 illustrates a high level block diagram of the interest intensity targeting module 114 in further detail, in one embodiment. The interest intensity targeting module 114 includes a data gathering module 300, a super fan analysis module 302, an engagement history analysis module 304, a contextual targeting module 306, an interest intensity scoring module 308, and a machine learning module 310. These modules may perform in conjunction with each other or independently to develop a scoring model for determining interest intensity levels in a particular object for users in a social networking system 100.

A data gathering module 300 retrieves information about users with respect to an object described in targeted interest intensity criteria 106 in an ad object 104, including information from user profile objects 108, edge objects 110, content objects 112, and page objects 120. The data gathering module 300 may retrieve user profile objects 108 that are associated with an object specified in the targeted interest intensity criteria 106 to determine interest intensity levels for users associated with the user profile objects 108. For example, a user profile object 108 may include an affinity score for an object in the social networking system 100, such as an object for the music artist Lady Gaga. The data gathering module 300 may also retrieve user profile objects 108 associated with users that have mentioned the object in a content post, such as a status update, comment, or photo upload. In another embodiment, the data gathering module 300 may retrieve user profile objects 108 of other users connected to users that have an interest in the object. In yet another embodiment, user profile objects 108 may be retrieved by the data gathering module 300 based on users viewing the object described in the targeted criteria 106 in the ad object 104. For example, if an advertisement targeted Lady Gaga and if a viewing user listened to the song “Edge of Glory” by Lady Gaga using an external music streaming service, then the user profile object 108 for that user may be retrieved by the data gathering module 300 because the object for Lady Gaga, an object property of the song “Edge of Glory” is associated with the user as a result of listening to the song. Thus, even if a user does not explicitly express an interest in Lady Gaga but has listened to a song by Lady Gaga, the user profile object 108 for that user may be retrieved by the data gathering module 300 in determining users with interest intensity levels for the object representing Lady Gaga. Similarly, edge objects 110, content objects 112, and page objects 120 may be retrieved by the data gathering module 300 based on their association with the object specified in the targeted interest intensity criteria 106.

A super fan analysis module 302 analyzes information about users of the social networking system 100 and their interest in an object described in the targeted interest intensity criteria 106 of an ad object 108. In one embodiment, the super fan analysis module 302 determines an affinity score of each user associated with the user profile objects 108 retrieved by the data gathering module 300 for the object described in the targeted interest intensity criteria 106. In that case, the computed affinity score may be used as the interest intensity level for the object. The super fan analysis module 302 may determine a user to be a super fan based on the interest intensity level meeting a predetermined threshold level, for example. In another embodiment, an interest intensity level may be calculated that incorporates a user's affinity score for the object while also including other factors with different weights, such as the user interacting with the object frequently over a given time period, installing applications associated with the object, and inviting other users connected to the user to engage with the object. For example, a user may enter into a sweepstakes promotion hosted on a page on the social networking system. The user may install an application associated with the page object to enter the sweepstakes contest, and may then interact with other users on the page hosting the contest. Furthermore, the user may post frequent content items, such as status updates, wall posts on other users' profile pages, and comments on the content items, that request other users to vote for the user in the sweepstakes contest. As a result, the user may influence other users to engage with the page hosting the contest, as well as install the application on the page in order to vote for the user. The interest intensity level of the user may be computed based on the affinity score for the object, in one embodiment. In another embodiment, the interest intensity level of the user may be determined based on a number of factors, including the frequency of interactions with the page object and the quality of interactions, such as installing an application associated with the page object, uploading photos and other content to the page, inviting other users connected to the user to install the application, and so forth. Other factors that may be included in determining the interest intensity level of the user, for purposes of determining whether the user can be categorized as a super fan, may include whether the user was successful in influencing other users to engage with the page object, as well as whether the user was successful in influencing other users to engage with other objects in the past. Users may then be determined to be super fans based on the interest intensity levels of the users meeting a predetermined threshold level.

The super fan analysis module 302 may determine users to be super fans based on these factors without determining an interest intensity level in the object, in one embodiment. Any combination of the factors listed above may be used to analyze users to determine whether the users are super fans of the object described in the targeted interest intensity criteria 106. For example, a super fan of a particular object, such as Lady Gaga, may be defined, in one embodiment, as a user that has performed a certain number of actions within the past week, such as listening to music by Lady Gaga and commenting on a fan page for Lady Gaga. In another embodiment, a super fan of a different object, such as Justin Bieber, may be defined differently, such as a user that has influenced other users to engage with an object associated with Justin Bieber, attended Justin Bieber concerts, purchased Justin Bieber merchandise, and posted multiple content items per day related to Justin Bieber. The definition of a super fan may be included in the targeted interest intensity criteria 106 for an ad object 104, in one embodiment. In another embodiment, a generic super fan definition may be applied for all objects by administrators of the social networking system 100. Using the generic super fan definition, a social networking system 100 may include whether a user qualifies as a super fan for a particular object in a prediction model for inferred targeting of advertisements to users of the social networking system 100 based on the content of the ads and the interests of the users. In a further embodiment, an advertiser 102 may interact with the social networking system 100 through a series of application programming interfaces (APIs) to define a super fan definition for a particular object in the social networking system 100. As a result, the advertiser 102 may target customized advertisements for users that have been identified by the advertiser 102 as super fans.

An engagement history analysis module 304 determines an analysis of the past engagement history of users associated with user profile objects 108 retrieved by the data gathering module 300 that are associated with the object specified in the targeted interest intensity criteria 106. In one embodiment, an engagement history of each user associated with the user profile objects 108 is analyzed by the engagement history analysis module 304 in conjunction with the machine learning module 310 and the interest intensity scoring module 308 to determine an interest intensity in the object specified in the targeted interest intensity criteria 106. For example, a user's interactions with an object on the social networking system, such as an object for “running,” may be analyzed by the engagement history analysis module 304 as a result of the “running” object being specified in the targeted interest intensity criteria 106 of an ad object 104. User interactions may include mentioning the object in a status update, photo upload, comment, or other content item posted to the social networking system 100. Other interactions may include installations of applications associated with the object, such as a third-party developed application that tracks a user's running workouts. In one embodiment, a “running” object may be associated with open graph objects defined by a third-party developer, such as “workouts” and “running routes” that a user may also interact with through open graph actions. As a result, interactions with these associated objects may also be analyzed by the engagement history analysis module 304 and factored into determining an interest intensity level for the user.

An engagement history analysis module 304 may also retrieve user interactions that may be analyzed to infer an interest in an object described in targeted interest intensity criteria 106 associated with an ad object 104. An interest intensity inference model may be generated for an object described in the targeted interest intensity criteria 106 based on a number of factors, including a user's past engagement history with other objects related to the object, behavior patterns of the user with respect to usage on the social networking system 100, the number of other users connected to the user having an interest in the object, the interest intensity of the other users connected to the user having an interest in the object, and other characteristics of the user, such as demographics, location, and keyword information extracted from a user profile associated with the user.

A contextual targeting module 306 analyzes targeted interest intensity criteria 106 of an ad object 104 that includes contextual targeting criteria for a specified object. For example, an advertiser 102 may wish to target an advertisement to users that are currently viewing the Coca-Cola page as well as users that have viewed the Coca-Cola page within a given time period. The advertiser 102 may not be associated with Coca-Cola, in one embodiment. In another embodiment, the contextual targeting module 306 may analyze information about users with respect to an object specified in the targeted interest intensity criteria 106 in real-time to target advertisements according to the targeted interest intensity criteria 106.

An interest intensity scoring module 308 may be used to determine interest intensity scores, or levels, for users of the social networking system based on a model for measuring interest intensity in an object described in targeted interest intensity criteria 106. Interest intensity scores may be determined based on whether users exhibit features in the model for the object described in the targeted interest intensity criteria 106. As a user exhibits more features in the model for the object, the interest intensity score for that user increases. In one embodiment, a model for an object specified in targeted interest intensity criteria 106 includes features that are unique to the object. For example, the San Francisco Giants may have unique features in the model for measuring interest intensity versus another Major League Baseball team, such as the Los Angeles Dodgers because the San Francisco Giants have been having record attendance, selling out most games, and have unique players and themes such as panda hats and beards. As a result, a user that may mention that they are attending a San Francisco Giants game in a comment, status update, or content item may have a lower interest intensity score than another fan that attends games regularly, posts status updates and comments frequently, and has photos of the user in a beard or with a panda hat. Conversely, a user that attends a Los Angeles Dodgers game may have a higher interest intensity score than a user attending a Giants game simply because of the past history of poor attendance of Dodgers fans as indicated on the social networking system 100. Because there is generally more interest in the Giants, a model measuring interest intensity in the Giants may rely on additional features, such as frequency of mentioning Giants in content items, groups joined on the social networking system associated with the Giants, applications installed on the social networking system associated with the Giants, and check-in events near a place or venue associated with the Giants.

Other features used by the interest intensity scoring module 308 in models to measure interest intensity may include features used to identify whether users are super fans, such as how influential a user is in affecting actions of other users connected to the user. In another embodiment, a model for measuring users' interest intensity levels in specified objects may be standardized for all objects, including features such as users' past history of engagement with the specified objects, as well as real-time information about engagement with the specified objects, such as recent status updates mentioning the objects, comments on pages associated with the objects, and the like. Other features may include other information about users, such as content items associated with the specified objects, keywords related to the specified objects extracted from content items posted by users, and whether users are connected to other users that have interest in the specified objects. Models may use weighted factors, regression analysis, and/or other statistical techniques to determine interest intensity levels.

A machine learning module 310 is used in the interest intensity targeting module 114 to select features for models generated for measuring interest intensity levels in objects described in targeted interest intensity criteria 106. In one embodiment, a social networking system 100 uses a machine learning algorithm to analyze features of a model for measuring interest intensity levels of users for a specified object. The machine learning module 310 may select user characteristics as features for the model for measuring interest intensity in an object, such as past user engagement with the object, previously determined affinity scores for the object, and whether other users connected to a user are interested in the object using at least one machine learning algorithm. In another embodiment, a machine learning algorithm may be used to optimize the selected features for the model measuring interest intensity levels in an object based on conversion rates of advertisements targeted to users identified from the model. A selected feature may be removed based on a lack of engagement by users that exhibit the selected feature. For example, a selected feature for a model for measuring interest intensity levels in an object for “coffee” may include a high affinity score for Starbucks Coffee based on numerous check-in events at Starbucks Coffee locations. However, suppose users exhibiting a high confidence score for checking into a Starbucks Coffee location in the next week based on numerous check-in events at Starbucks Coffee locations do not engage with the advertisement in expected numbers. The machine learning algorithm may deselect that feature, the numerous check-in events, in the model for determining interest intensity scores of users for “coffee,” in one embodiment. In another embodiment, the interest intensity scores may be reduced by decreasing the weight placed on the check-in events at Starbucks Coffee locations. Performance metrics of advertisements, such as whether a user engaged with the advertisement, may be used in this way to train the machine learning algorithm to select, deselect, or modify weights of features in the model.

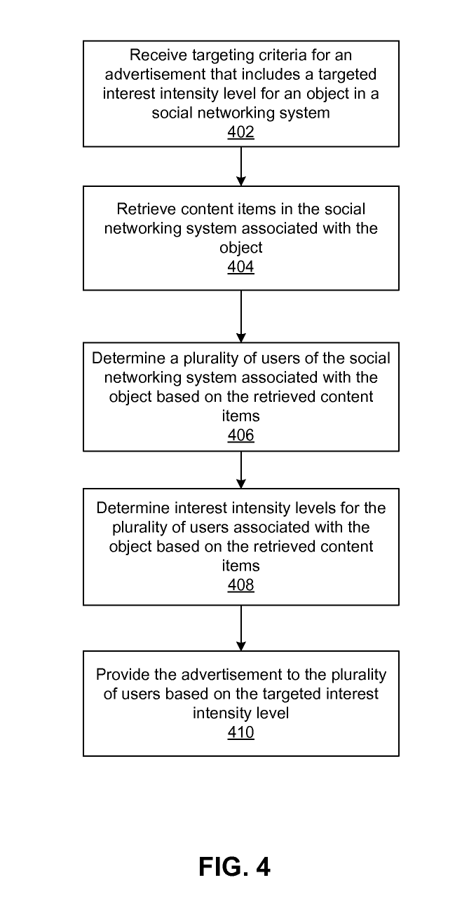

FIG. 4 illustrates a flow chart diagram depicting a process of targeting advertisements to users of a social networking system based on targeted interest intensity criteria, in accordance with an embodiment of the invention. A social networking system 100 receives 402 targeting criteria for an advertisement that includes a targeted interest intensity level for an object in the social networking system 100. The object described in the targeting criteria may represent a specific object in the social networking system 100, such as a content item, a page, an event, a location, an application, a group, a user, an entity, a concept, or an open graph object defined by a third-party developer, in one embodiment. In another embodiment, the object described in the targeting criteria for an advertisement includes an object that is associated with other objects, such as Britney Spears, represented as an artist object in the social networking system that is connected to song objects, album objects, and genre objects. As a result, a user listening to the song “I Wanna Go” by Britney Spears and sharing that listening action with the social networking system 100 may be indicating an interest in the artist object for Britney Spears.

Content items in a social networking system associated with the object are retrieved 404. For example, a status message update that includes the name of the artist object specified in the targeting criteria may be retrieved 404. Other types of content items, including page posts, video uploads, check-in events, application installations, and application updates made on behalf of the user may also be retrieved 404. Additionally, content items that are associated with the event as a result of a mention of the object within the content item or otherwise linked to the event may also be retrieved 404. For example, a user may mention the object described in the targeting criteria in a comment to a content item posted on another user's profile. As a result, the content item maybe retrieved even though the content item may not have mentioned the object. In one embodiment, a content item may be associated with an object based on an association made by a user of the social networking system, such as a tag of a page in a photo, linking the photo object and the page object for the page through the tag, or the association made by the user. In that embodiment, the content item, or the photo object, associated with an object specified in the targeting criteria, the page object, would also be retrieved 404.

After the content items in a social networking system associated with the object have been retrieved 404, the social networking system determines 406 a plurality of users of the social networking system associated with the object based on the retrieved content items. In the social networking system 100, the retrieved content items are associated with users of the social networking system 100 that authored the content items. Those users are determined 406 by the social networking system to be associated with the object. In another embodiment, other users connected to the users that authored the retrieved content items may also be determined 406 to be associated with the object. The other users connected to the users having an interest in the object may be determined 406 to be associated with the object based on an affinity score of the other users for the users having the interest in the object. In addition, the social networking system 100 may determine 406 a plurality of users of the social networking system to be associated with the object based on a rule that uses the object. For example, users that are located within 50 miles of a particular location, such as the Bellagio Hotel in Las Vegas, Nev., may be determined 406 to be associated with the object because a rule may be programmed to target those users.

After the plurality of users of the social networking system associated with the object based on the retrieved content items has been determined 406, interest intensity levels are determined 408 for the plurality of users associated with the object based on the retrieved content items. Interest intensity levels in the object may be determined 408 based on a number of factors in a model for measuring the interest intensity in the specified object, including users' past history of engagement with the specified object, as well as real-time information about engagement with the specified object, such as recent status updates mentioning the object, comments on pages associated with the object, and the like. Other factors may include other information about users, such as content items associated with the specified object, keywords related to the specified object extracted from content items posted by users, and whether users are connected to other users that have interest in the object. In another embodiment, the model for measuring interest intensity in a specified object may be customized for the object being targeted.

Once interest intensity levels are determined 408 for the plurality of users associated with the object, the advertisement is provided 410 to the plurality of users based on the targeted interest intensity level. The advertisement may be provided 410 for display to a subset of the plurality of users based on a predetermined threshold interest intensity level. For example, an interest intensity level of 70 may be required to provide 410 the advertisement to a user of the social networking system 100. The predetermined threshold interest intensity level may be determined by administrators of a social networking system 100, in one embodiment, based on empirical data regarding the effectiveness of the targeting of prior advertisements. In another embodiment, the predetermined threshold interest intensity level may be determined by the advertiser of the advertisement. In a further embodiment, a sample of the plurality of users are provided the advertisement based on interest intensity levels and other information known about users, such as affinity scores for other objects related to the specified object in the targeting criteria.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
receiving targeting criteria for an advertisement on a social networking system, where the targeting criteria identifies a targeted interest intensity level for an object in the social networking system;
retrieving a plurality of content items associated with a plurality of users of the social networking system, where the plurality of content items are associated with the object;
determining a plurality of interest intensity scores for the plurality of users associated with the plurality of content items associated with the object;
determining a targeting cluster of users associated with the object for the advertisement from the plurality of users based on the plurality of interest intensity scores and the targeted interest intensity level for the object; and
for a viewing user, providing the advertisement for display to the viewing user based on the viewing user being in the targeting cluster of users and based on the interest intensity score of the viewing user.

2. The method of claim 1, wherein determining a targeting cluster of users associated with the object for the advertisement from the plurality of users based on the plurality of interest intensity scores and the targeted interest intensity level for the object further comprises:
determining identifying information of users of the social networking system that are associated with the object.

3. The method of claim 1, wherein determining a targeting cluster of users associated with the object for the advertisement from the plurality of users based on the plurality of interest intensity scores and the targeted interest intensity level for the object further comprises:
determining identifying information of a plurality of inferred users of the social networking system that are associated with other users that are associated with the object;
determining the targeting cluster of users to include a subset of the plurality of inferred users that are associated with the other users that are associated with the object based on information about the subset of the plurality of inferred users.

4. The method of claim 1, wherein a retrieved content item further comprises a status message including a mention of the object received from a user device associated with a user of the social networking system.

5. The method of claim 1, wherein a retrieved content item further comprises a page post on a page of the social networking system associated with the object.

6. The method of claim 1, wherein a retrieved content item further comprises an interaction received from a user device associated with a user of the social networking system with the object.

7. The method of claim 1, wherein a retrieved content item further comprises a photo associated with the object received from a user device associated with a user of the social networking system.

8. The method of claim 1, wherein determining a plurality of interest intensity scores for the plurality of users associated with the plurality of content items associated with the object further comprises:
generating an interest intensity scoring model for the advertisement based on the retrieved content items associated with the object; and
for each user of the targeting cluster of users, determining an interest intensity score based on the interest intensity scoring model and the retrieved content items for the user.

9. The method of claim 1, wherein providing the advertisement for display to the viewing user further comprises:
retrieving a predetermined threshold interest intensity score for the advertisement; and
responsive to the interest intensity score of the viewing user exceeding the predetermined threshold interest intensity score for the advertisement, providing the advertisement for display to the viewing user.

10. The method of claim 1, wherein the targeting criteria for the advertisement further comprises a range of targeted interest intensity levels for an object in the social networking system.

11. The method of claim 1, wherein determining a plurality of interest intensity scores for the plurality of users associated with the plurality of content items associated with the object further comprises:
determining an interest intensity score for each user of the plurality of users based on a plurality of content items associated with user using a model for measuring interest intensity in the object.

12. The method of claim 1, wherein determining a plurality of interest intensity scores for the plurality of users associated with the plurality of content items associated with the object further comprises:
determining an interest intensity score for each user of the plurality of users based on a qualitative analysis of a plurality of content items associated with user using a model for measuring interest intensity in the object.

13. The method of claim 1, wherein the targeting criteria for an advertisement further comprises a definition of a super fan of the object, and wherein determining a targeting cluster of users associated with the object for the advertisement from the plurality of users further comprises:
determining whether each user of the plurality of users meets the definition of a super fan of the object; and
responsive to the a user of the plurality of users meeting the definition of a super fan of the object, determining the user as part of the targeting cluster of users for the advertisement.

14. A method, comprising:
maintaining a plurality of user profile objects on a social networking system, the plurality of user profile objects representing a plurality of users of the social networking system;
maintaining a plurality of edge objects connecting the plurality of user profile objects and a plurality of nodes in the social networking system, where a subset of the plurality of nodes represent a plurality of concepts;
determining a prediction model for scoring a plurality of advertisements, where the prediction model includes at least one targeted interest intensity level in at least one of the plurality of concepts as at least one feature in the prediction model;
determining a plurality of prediction scores for the plurality of advertisements for each user of the plurality of users based on the prediction model; and
for a viewing user of the social networking system, providing an advertisement for display to the viewing user based on the prediction score of the advertisement.

15. The method of claim 14, wherein a subset of the plurality of edge objects are generated based on a plurality of graph actions performed by a subset of the plurality of users on a plurality of graph objects on external systems, the plurality of graph actions and the plurality of graph objects defined by a plurality of entities external to the social networking system.

16. The method of claim 14, wherein the prediction model comprises a machine learning model.

17. The method of claim 14, wherein determining a prediction model for scoring a plurality of advertisements, where the prediction model includes at least one targeted interest intensity level in at least one of the plurality of concepts as at least one feature in the prediction model further comprises:
generating the prediction model using a matching algorithm; and
determining the at least one feature in the prediction model as at least one of the plurality of concepts based on information about a content item received from a user of the plurality of users.

18. The method of claim 14, wherein determining a prediction model for scoring a plurality of advertisements, where the prediction model includes at least one targeted interest intensity level in at least one of the plurality of concepts as at least one feature in the prediction model further comprises:
receiving a performance metric for a feature in the prediction model; and
modifying the prediction model based on the performance metric for the feature.

19. The method of claim 14, wherein determining a prediction model for scoring a plurality of advertisements, where the prediction model includes at least one targeted interest intensity level in at least one of the plurality of concepts as at least one feature in the prediction model further comprises:
receiving real-time interest information about at least one of the plurality of concepts for a user in the social networking system; and
determining the at least one feature in the prediction model as received real-time interest information about the at least one of the plurality of concepts for the user.

20. A method, comprising:
maintaining a plurality of user profile objects on a social networking system, the plurality of user profile objects representing a plurality of users of the social networking system;
receiving an advertisement having targeting criteria identifying a targeted interest intensity level in an object in the social networking system;
retrieving a plurality of edge objects on the social networking system associated with a subset of the plurality of users where each edge object is associated with the object identified in the targeting criteria of the advertisement;
determining a plurality of prediction scores for the advertisement for the subset of the plurality of users associated with the plurality of edge objects, the plurality of prediction scores based upon a prediction model for scoring the advertisement;
determining a targeting cluster of users for the advertisement based on the plurality of prediction scores of the subset of the plurality of users of the social networking system associated with the plurality of edge objects; and
for a viewing user of the social networking system in the targeting cluster of users, providing the advertisement for display to the viewing user based on a prediction score for the advertisement for the viewing user.

21. The method of claim 20, wherein determining a plurality of prediction scores for the advertisement for the subset of the plurality of users associated with the plurality of edge objects further comprises:
for each user of the subset of the plurality of users associated with the plurality of edge objects, determining an interest intensity level in the object in the targeting criteria of the advertisement; and
determining the prediction score for the advertisement for each user of the subset of the plurality of users associated with the plurality of edge objects based on the determined interest intensity level in the object for the user.

22. The method of claim 20, wherein determining a plurality of prediction scores for the advertisement for the subset of the plurality of users associated with the plurality of edge objects further comprises:
for each user of the subset of the plurality of users associated with the plurality of edge objects, retrieving an affinity score of the user with respect to the object included in the targeting criteria of the advertisement; and
determining the prediction score for the advertisement for each user of the subset of the plurality of users associated with the plurality of edge objects based on the affinity score of the user with respect to the object included in the targeting criteria of the advertisement.

23. The method of claim 20, further comprising:
receiving information that a viewing user is currently viewing the object included in the targeting criteria of the advertisement; and
modifying a bid price for the viewing user for targeting the advertisement based on the information that the viewing user is currently viewing the object included in the targeted criteria of the advertisement.

24. The method of claim 20, wherein determining a plurality of prediction scores for the advertisement for the subset of the plurality of users associated with the plurality of edge objects further comprises:
for each user in the subset of the plurality of users associated with the plurality of edge objects, determining a frequency of the user interacting with the object included in the targeting criteria based on the edge objects associated with the user; and
determining a prediction score for the advertisement for each user in the subset of the plurality of users associated with the plurality of edge objects based on the determined frequencies.

25. The method of claim 20, wherein determining a plurality of prediction scores for the advertisement for the subset of the plurality of users associated with the plurality of edge objects further comprises:
for each user in the subset of the plurality of users associated with the plurality of edge objects, determining whether the user is a super fan of the object included in the targeting criteria based on the edge objects associated with the user; and
determining a prediction score for the advertisement for each user in the subset of the plurality of users associated with the plurality of edge objects based on the user being a super fan of the object included in the targeting criteria.

26. The method of claim 20, further comprising:
receiving a first bid price for a first interest intensity level in the object included in the targeting criteria of the advertisement; and
receiving a second bid price for a second interest intensity level in the object included in the targeting criteria of the advertisement,
wherein the first bid price for the first interest intensity level is higher than the second bid price for the second interest intensity level responsive to the first interest intensity level being greater than the second interest intensity level.

27. The method of claim 20, further comprising:
receiving a reserve bid price for the advertisement based on the targeted interest intensity level in the object included in the targeting criteria of the advertisement,
wherein providing the advertisement for display to the viewing user is further based on receiving the reserve bid price.
